(19) United States
(12) Patent Application Publication
(10) Pub. No.: US 2012/0155920 A1
(43) Pub. Date: Jun. 21, 2012

(54) IMAGING MEMBERS HAVING AN ENHANCED CHARGE TRANSPORT LAYER

(75) Inventor: JIN WU, Pittsford, NY (US)

(73) Assignee: XEROX CORPORATION, Norwalk, CT (US)

(21) Appl. No.: 12/970,800

(22) Filed: Dec. 16, 2010

(51) Int. Cl. G03G 15/02; G03G 5/06

(52) U.S. Cl. 399/159; 430/58.8

(57) ABSTRACT

The presently disclosed embodiments are directed to charge transport layers useful in electrostatography. More particularly, the embodiments pertain to an improved electrostatographic imaging member having a specific photoreceptor material package comprising an undercoat layer, a charge generation layer, a charge transport layer comprising Tm-TBD/tris(butadienylaryl)amine, and an overcoat layer. The charge transport layer molecule provides substantially reduced C zone residual potential and therefore alleviates the problems of low optical density and ghosting.

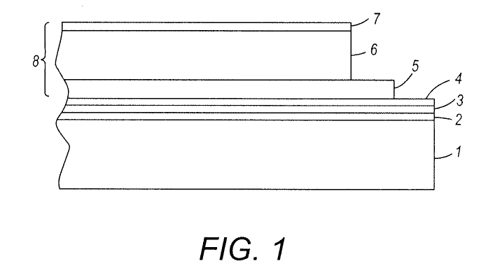

### BACKGROUND

The presently disclosed embodiments relate generally to layers that are useful in imaging apparatus members and components, for use in electrostatographic, including digital, apparatuses. More particularly, the present embodiments pertain to an improved electrostatographic imaging member comprising a charge transport layer having a novel formulation that provides improved high speed performance.

Typically, the electrophotographic imaging members are, for example, photoreceptors, commonly utilized in electrophotographic (xerographic) processing system. Generally, these imaging members comprise at least a supporting substrate and at least one imaging layer comprising a thermoplastic polymeric matrix material. In an electrophotographic imaging member or photoreceptor, the photoconductive imaging layer may comprise only a single photoconductive layer or multiple of layers such as a combination of a charge generating layer and one or more charge transport layer(s).

Electrophotographic imaging members can have two distinctively different configurations. For example, they can comprise a flexible member, such as a flexible scroll or a belt containing a flexible substrate. Since typical flexible electrophotographic imaging members exhibit spontaneous upward imaging member curling after completion of solution coating the outermost exposed imaging layer, an anticurl back coating is therefore required to be applied to back side of the flexible substrate support to counteract/balance the curl and provide the desirable imaging member flatness. Alternatively, the electrophotographic imaging members can also be a rigid member, such as those utilizing a rigid substrate support drum. For these drum imaging members, having a thick rigid cylindrical supporting substrate bearing the imaging layer(s), there is no exhibition of the curl-up problem, and thus, there is no need for an anticurl back coating layer.

Electrophotographic flexible belt imaging members may include a photoconductive layer including a single layer or composite layers. The flexible belt electrophotographic imaging members may be seamless or seamed belts. Seamed belts are usually formed by cutting a rectangular sheet from a web, overlapping opposite ends, and welding the overlapped ends together to form a welded seam. Typical electrophotographic imaging member belts include a charge transport layer and a charge generating layer on one side of a supporting substrate layer and an anticurl back coating coated onto the opposite side of the substrate layer. By comparison, a typical electrographic imaging member belt does, however, have a more simple material structure; it includes a dielectric imaging layer on one side of a supporting substrate and an anti-curl back coating on the opposite side of the substrate to render flatness. Since typical negatively-charged flexible electrophotographic imaging members exhibit undesirable upward imaging member curling after completion of coating the top outermost charge transport layer, an anticurl back coating, applied to the backside, is required to balance the curl. Thus, the application of anticurl back coating is necessary to provide the appropriate imaging member with desirable flatness.

In the case where the charge generating layer (CGL) is sandwiched between the outermost exposed charge transport layer (CTL) and the electrically conducting layer, the outer surface of the charge transport layer is charged negatively and the conductive layer is charged positively. The CGL then should be capable of generating electron hole pair when exposed image wise and inject only the holes through the charge transport layer. In the alternate case when the charge transport layer is sandwiched between the CGL and the conductive layer, the outer surface of Gen layer is charged positively while conductive layer is charged negatively and the holes are injected through from the CGL to the charge transport layer. The CTL should be able to transport the holes with as little trapping of charge as possible. In a typical flexible imaging member web like photoreceptor, the charge conductive layer may be a thin coating of metal on a flexible substrate support layer.

An electrophotographic imaging process involves the steps of applying a uniform surface charge to a photoconductor, and exposing the photoconductor to imaging radiation that discharges the photoconductor in selected areas to define a latent electrostatic image. The latent image is then developed by the deposition of a dry or liquid toner on the photoconductor surface. The toner electrostatically adheres to the imaged areas of the photoconductor to form a developed image that is transferred to an imaging substrate. The optical density of the deposited toner, and of the image transferred to the imaging substrate, is a function of the potential difference, or “contrast,” between imaged and unimaged areas of the photoconductor. Thus, the degree of contrast depends on the difference between the surface charge potential initially applied to the photoconductor and the potential of the imaged areas after discharge.

To produce high contrast, and hence good optical density, the difference between the surface charge potential and the discharged potential in the imaged areas should be as high as possible. Unfortunately, the discharge process does not immediately reduce the surface charge potential to zero, but rather produces a residual electrostatic potential that limits the degree of contrast that can be achieved. The existence of the residual potential can be explained by examining the mechanics of the discharge process, which has two components: an initial, rapid discharge phase and a subsequent, gradual discharge phase. In the rapid discharge phase, the imaging radiation generates charge carriers that quickly neutralize the surface charge in imaged areas to lower the surface potential. However, a portion of the charge carriers becomes trapped within the photoconductor bulk, resulting in the maintenance of a residual potential in the imaged areas. Over time, a gradual discharge phase occurs, in which the residual potential slowly drops to zero as the trapped charge carriers are released by thermal excitation. Nevertheless, complete discharge may not occur until after the toner development stage of the electrophotographic cycle, and therefore may have no practical significance in achieving high contrast for toner deposition.

In addition to decreasing optical density, residual potential can also contribute to the appearance of undesirable “ghost” images in previously imaged areas of the photoconductor. A ghost image is any visible remnant of a previous image superimposed on a present image. The ghosting problem can result from a variety of mechanisms. One mechanism is the accumulation of trapped charge carriers in discharged areas over a series of imaging cycles that results in a “build-up” of residual electrostatic potential. The accumulation of trapped charge carriers leads to a higher residual potential in previously imaged areas of the photoconductor relative to previously unimaged areas. The accumulation of trapped charge carriers may also create space charge fields that decrease conductivity in the previously imaged areas. The presence of higher residual potentials and/or space charge fields acts as a nonuniformity that decreases optical density upon development, and produces ghost images in areas in which differences in residual potential or conductivity exist.

As more advanced, higher speed electrophotographic copiers, duplicators and printers were developed, other problems were encountered. For example, degradation of image quality was encountered during extended cycling. The complex, highly sophisticated duplicating and printing systems operating at very high speeds have placed stringent requirements including narrow operating limits on photoreceptors. For example, the numerous layers used in many modern photoconductive imaging members must be highly flexible, adhere well to adjacent layers, and exhibit predictable electrical characteristics within narrow operating limits to provide excellent toner images over many thousands of cycles. One type of multilayered photoreceptor that has been employed as a belt in electrophotographic imaging systems comprises a substrate, a conductive layer, an optional blocking layer, an optional adhesive layer, a charge generating layer, a CTL and a conductive ground strip layer adjacent to one edge of the imaging layers, and an optional overcoat layer adjacent to another edge of the imaging layers. Such a photoreceptor usually further comprises an anticurl back coating layer on the side of the substrate opposite the side carrying the conductive layer, support layer, blocking layer, adhesive layer, CGL, CTL and other layers.

Although excellent toner images may be obtained with multilayered belt or drum photoreceptors, it has been found that as more advanced, higher speed electrophotographic copiers, duplicators and printers are developed, there is a greater demand on copy quality. A delicate balance in charging image and bias potentials, and characteristics of the toner and/or developer, must be maintained. This places additional constraints on the quality of photoreceptor manufacturing, and thus, on the manufacturing yield.

Despite the various approaches that have been taken for forming imaging members, there remains a need for improved imaging member design, to provide improved imaging performance at higher speeds, longer lifetime, and the like.

Conventional photoreceptors and their materials are disclosed in Katayama et al., U.S. Pat. No. 5,489,496; Yashiki, U.S. Pat. No. 4,579,801; Yashiki, U.S. Pat. No. 4,518,669; Seki et al., U.S. Pat. No. 4,775,605; Kawahara, U.S. Pat. No. 5,656,407; Markovics et al., U.S. Pat. No. 5,641,599; Monbaliu et al., U.S. Pat. No. 5,344,734; Terrell et al., U.S. Pat. No. 5,721,080; and Yoshihara, U.S. Pat. No. 5,017,449, which are herein all incorporated by reference.

More recent photoreceptors are disclosed in Fuller et al., U.S. Pat. No. 6,200,716; Maty et al., U.S. Pat. No. 6,180,309; and Dinh et al., U.S. Pat. No. 6,207,334, which are all herein incorporated by reference.

The terms “charge blocking layer”, “hole blocking layer” and “blocking layer” are generally used interchangeably with the phrase “undercoat layer.” The terms “charge generation layer,” “charge generating layer,” and “charge generator layer”) are generally used interchangeably with the phrase “photogenerating layer.” The terms “charge transport molecule” are generally used interchangeably with the terms “hole transport molecule.” The term “electrostatographic” includes “electrophotographic” and “xerographic.” The term “photoreceptor” or “photoconductor” is generally used interchangeably with the terms “imaging member.”

### SUMMARY

In embodiments, there is provided an electrophotographic imaging member comprising: a substrate; an undercoat layer disposed on the substrate; a charge generation layer disposed on the undercoat layer; a charge transport layer disposed on the charge generation layer, wherein the charge transport layer comprises a polymeric binder, and a combination of hole transport molecules comprising N,N,N′,N′-tetra-p-tolyl-1,1′-biphenyl-4,4′-diamine and a tris(butadienylaryl)amine compound; and an overcoat layer disposed on the charge transport layer.

Another embodiment provides an imaging member comprising: a substrate; an undercoat layer; and an imaging layer disposed on the undercoat layer, wherein the imaging layer comprises N,N,N′,N′-tetra-p-tolyl-1,1′-biphenyl-4,4′-diamine and a tris(butadienylaryl)amine compound; and an overcoat layer disposed on the imaging layer.

In yet another embodiment, there is an image forming apparatus comprising: an imaging member further comprising a substrate, an undercoat layer, an imaging layer disposed on the undercoat layer, wherein the imaging layer comprises N,N,N′,N′-tetra-p-tolyl-1,1′-biphenyl-4,4′-diamine and a tris(butadienylaryl)amine compound, and an overcoat layer disposed on the imaging layer; a charging unit that applies electrostatic charge on the imaging member; a developing unit that develops toner image onto the imaging member; a transfer unit that transfers the toner image from the imaging member to a media; and a cleaning unit that cleans the imaging member.

### BRIEF DESCRIPTION OF THE DRAWINGS

For a better understanding of the present embodiments, reference may be had to the accompanying FIGURE.

The FIGURE illustrates an electrophotographic imaging member having various layers in accordance with the present embodiments.

### DETAILED DESCRIPTION

In the following description, reference is made to the accompanying drawings, which form a part hereof and which illustrate several embodiments. It is understood that other embodiments may be utilized and structural and operational changes may be made without departure from the scope of the present disclosure. The same reference numerals are used to identify the same structure in different figures unless specified otherwise. The structures in the figures are not drawn according to their relative proportions and the drawings should not be interpreted as limiting the disclosure in size, relative size, or location.

The presently disclosed embodiments are directed generally to an improved electrostatographic imaging member comprising a charge transport layer having a novel formulation, namely, a specific combination of hole transport molecules to achieve a substantially reduced C zone residual potential (Vᵣ) for high speed applications. The combination of hole transport molecules comprises N,N,N′,N′-tetra-p-tolyl-1,1′-biphenyl-4,4′-diamine (TmTBD) and tris(butadienylaryl)amine. In addition, the imaging member further comprises an overcoat layer having a specific formulation comprising N,N′-diphenyl-N,N′-bis(3-hydroxyphenyl)-[1,1′-biphenyl]-4,4′-diamine (DHTBD) and a melamine resin overcoat layer. The imaging members of the present embodiments have demonstrated substantially reduced C zone residual potential and therefore alleviate the problems of low optical density and ghosting.

The FIGURE illustrates a typical electrophotographic photoreceptor showing various layers. Multilayered electrophotographic photoreceptors or imaging members can have at least two layers, and may include a substrate, a conductive layer, an undercoat layer, an optional adhesive layer, a photogenerating layer, a charge transport layer, an optional overcoat layer and, in some embodiments, an anticurl backing layer. In the multilayer configuration, the active layers of the photoreceptor are the charge generation layer (CGL) and the charge transport layer (CTL). Enhancement of charge transport across these layers provides better photoreceptor performance. Overcoat layers are commonly included to increase mechanical wear and scratch resistance.

An imaging member may be provided in a number of forms. For example, the imaging member may be a homogeneous layer of a single material or it may be a composite layer containing a photoconductor and another material. In addition, the imaging member may be layered. These layers can be in any order, and sometimes can be combined in a single or mixed layer. The undercoating layer is generally located between the substrate and the imaging layer, although additional layers may be present and located between these layers. The imaging member may also include a charge generating layer and a charge transport layer.

The Substrate

Typically, a flexible or rigid substrate 1 is provided with an optional electrically conductive surface or coating 2. The substrate may be opaque or substantially transparent and may comprise any suitable material having the required mechanical properties. Accordingly, the substrate may comprise a layer of an electrically non-conductive or conductive material such as an inorganic or an organic composition. As electrically non-conducting materials, there may be employed various resins known for this purpose including polyesters, polycarbonates, polyamides, polyurethanes, and the like which are flexible as thin webs. Any suitable electrically conductive material can be employed, such as for example, metal or metal alloy. Electrically conductive materials include copper, brass, nickel, zinc, chromium, stainless steel, conductive plastics and rubbers, aluminum, semitransparent aluminum, steel, cadmium, silver, gold, zirconium, niobium, tantalum, vanadium, hafnium, titanium, nickel, niobium, stainless steel, chromium, tungsten, molybdenum, paper rendered conductive by the inclusion of a suitable material therein or through conditioning in a humid atmosphere to ensure the presence of sufficient water content to render the material conductive, indium, tin, metal oxides, including tin oxide and indium tin oxide, and the like. It could be single metallic compound or dual layers of different metals and/or oxides.

The substrate 1 can also be formulated entirely of an electrically conductive material, or it can be an insulating material including inorganic or organic polymeric materials, such as MYLAR, a commercially available biaxially oriented polyethylene terephthalate from DuPont, or polyethylene naphthalate available as KALEDEX 2000, with a ground plane layer 2 comprising a conductive titanium or titanium/zirconium coating, otherwise a layer of an organic or inorganic material having a semiconductive surface layer, such as indium tin oxide, aluminum, titanium, and the like, or exclusively be made up of a conductive material such as, aluminum, chromium, nickel, brass, other metals and the like. The thickness of the support substrate depends on numerous factors, including mechanical performance and economic considerations.

The substrate 1 may have a number of many different configurations, such as for example, a plate, a cylinder, a drum, a scroll, an endless flexible belt, and the like. In the case of the substrate being in the form of a belt, the belt can be seamed or seamless.

The thickness of the substrate depends on numerous factors, including flexibility, mechanical performance, and economic considerations. The thickness of the support substrate of the present embodiments may be at least about 500 microns, or no more than about 3,000 microns, or be at least about 750 microns, or no more than about 2500 microns.

An exemplary substrate support is not soluble in any of the solvents used in each coating layer solution, is optically transparent or semi-transparent, and is thermally stable up to a high temperature of about 150° C. A substrate support used for imaging member fabrication may have a thermal contraction coefficient ranging from about 1×10⁻⁵ per ° C., to about 3×10⁻⁵ per ° C., and a Young's Modulus of between about 5×10⁻⁵ psi (3.5×10⁻⁴ Kg/cm²) and about 7×10⁻⁵ psi (4.9×10⁻⁴ Kg/cm²).

The Ground Plane

In embodiments where the substrate layer is not conductive, the surface thereof may be rendered electrically conductive by an electrically conductive ground plane/coating 2. The conductive coating may vary in thickness over substantially wide ranges depending upon the optical transparency, degree of flexibility desired, and economic factors.

The electrically conductive ground plane 2 may be an electrically conductive metal layer which may be formed, for example, on the substrate by any suitable coating technique, such as a vacuum depositing technique. Metals include aluminum, zirconium, niobium, tantalum, vanadium, hafnium, titanium, nickel, stainless steel, chromium, tungsten, molybdenum, and other conductive substances, and mixtures thereof. The conductive layer may vary in thickness over substantially wide ranges depending on the optical transparency and flexibility desired for the electrophotoconductive member. Accordingly, for a flexible photoresponsive imaging device, the thickness of the conductive layer may be at least about 20 Angstroms, or no more than about 750 Angstroms, or at least about 50 Angstroms, or no more than about 200 Angstroms for an optimum combination of electrical conductivity, flexibility and light transmission.

Regardless of the technique employed to form the metal layer, a thin layer of metal oxide forms on the outer surface of most metals upon exposure to air. Thus, when other layers overlying the metal layer are characterized as “contiguous” layers, it is intended that these overlying contiguous layers may, in fact, contact a thin metal oxide layer that has formed on the outer surface of the oxidizable metal layer. Generally, for rear erase exposure, a conductive layer light transparency of at least about 15 percent is desirable. The conductive layer need not be limited to metals. Other examples of conductive layers may be combinations of materials such as conductive indium tin oxide as transparent layer for light having a wavelength between about 4000 Angstroms and about 9000 Angstroms or a conductive carbon black dispersed in a polymeric binder as an opaque conductive layer.

The Undercoat Layer

After deposition of an electrically conductive ground plane layer, an undercoat layer 3 may be applied thereto. Electron blocking layers for positively charged photoreceptors allow holes from the imaging surface of the photoreceptor to migrate toward the conductive layer. For negatively charged photoreceptors, any suitable undercoat layer capable of forming a barrier to prevent hole injection from the conductive layer to the opposite photoconductive layer may be utilized. The undercoat layer may include polymers such as polyvinylbutryral, epoxy resins, polyesters, polysiloxanes, polyamides, polyurethanes and the like, or may be nitrogen containing siloxanes or nitrogen containing titanium compounds such as trimethoxysilyl propylene diamine, hydrolyzed trimethoxysilyl propyl ethylene diamine, N-beta-(aminoethyl) gamma-amino-propyl trimethoxy silane, isopropyl 4-aminobenzene sulfonyl, di(dodecylbenzene sulfonyl)titanate, isopropyl di(4-aminobenzoyl)isostearoyl titanate, isopropyl tri(N-ethylamino-ethylamino)titanate, isopropyl trianthranil titanate, isopropyl tri(N,N-dimethylethylamino)titanate, titanium-4-amino benzene sulfonate oxyacetate, titanium 4-aminobenzoate isostearate oxyacetate, [H₂N(CH₂)₄]CH₃Si(OCH₃)₂, (gamma-aminobutyl)methyl diethoxysilane, and [H₂N(CH₂)₃]CH₃Si(OCH₃)₂ (gamma-aminopropyl)methyl diethoxysilane, as disclosed in U.S. Pat. Nos. 4,338,387, 4,286,033 and 4,291,110.

General embodiments of the undercoat layer 3 may comprise a metal oxide and a resin binder. The metal oxides that can be used with the embodiments herein include, but are not limited to, titanium oxide, zinc oxide, tin oxide, aluminum oxide, silicon oxide, zirconium oxide, indium oxide, molybdenum oxide, and mixtures thereof. Undercoat layer binder materials may include, for example, polyesters, MOR-ESTER 49,000 from Morton International Inc., VITEL PE-100, VITEL PE-200, VITEL PE-200D, and VITEL PE-222 from Goodyear Tire and Rubber Co., polyarylates such as ARDEL from AMOCO Production Products, polysulfone from AMOCO Production Products, polyurethanes, and the like.

The undercoat layer 3 should be continuous. The thickness of the undercoat layers in belt photoreceptors are normally less than about 0.5 micron because greater thicknesses may lead to undesirably high residual voltage. An undercoat layer of between about 0.005 micron and about 0.3 micron is used because charge neutralization after the exposure step is facilitated and optimum electrical performance is achieved. A thickness of between about 0.03 micron and about 0.06 micron is used for undercoat layers for optimum electrical behavior. However, in drum based photoreceptors the undercoat layer can have a thickness of up to 30 microns, or from about 4 microns to about 25 microns.

In the present embodiments, the undercoat layer has a thickness of from about 0.5 micron to about 4 microns, or from 1 micron to 2 microns.

The undercoat layer may be applied by any suitable conventional technique known in the art, such as spraying, dip coating, draw bar coating, gravure coating, silk screening, air knife coating, reverse roll coating, vacuum deposition, chemical treatment and the like. Additional vacuuming, heating, drying and the like, may be used to remove any solvent remaining after the application or coating to form the undercoat layer.

The Adhesive Layer

An optional separate adhesive interfacial layer 4 may be provided in certain configurations, such as for example, in flexible web configurations. In the embodiment illustrated in the FIGURE, the interfacial layer would be situated between the blocking layer 3 and the charge generation layer 5. The interfacial layer may include a copolyester resin. Exemplary polyester resins which may be utilized for the interfacial layer include polyarylatepolyvinylbutyrals, such as ARDEL POLYARYLATE (U-100) commercially available from Toyota Hsutsu Inc., VITEL PE-100, VITEL PE-200, VITEL PE-200D, and VITEL PE-222, all from Bostik, 49,000 polyester from Rohm Hass, polyvinyl butyral, and the like. The adhesive interfacial layer may be applied directly to the hole blocking layer 3. Thus, the adhesive interfacial layer in embodiments is in direct contiguous contact with both the underlying hole blocking layer 3 and the overlying charge generation layer 5 to enhance adhesion bonding to provide linkage. In yet other embodiments, the adhesive interfacial layer is entirely omitted.

Any suitable solvent or solvent mixtures may be employed to form a coating solution of the polyester for the adhesive interfacial layer. Solvents may include tetrahydrofuran, toluene, monochlorobenzene, methylene chloride, cyclohexanone, and the like, and mixtures thereof. Any other suitable and conventional technique may be used to mix and thereafter apply the adhesive layer coating mixture to the hole blocking layer. Application techniques may include spraying, dip coating, roll coating, wire wound rod coating, and the like. Drying of the deposited wet coating may be effected by any suitable conventional process, such as oven drying, infra red radiation drying, air drying, and the like.

The adhesive interfacial layer may have a thickness of at least about 0.01 micron, or no more than about 900 microns after drying. In embodiments, the dried thickness is from about 0.03 micron to about 1 micron.

The Imaging Layer

At least one imaging layer 8 is formed on the adhesive layer 4 or the undercoat layer 3. The imaging layer 8 may be a single layer that performs both charge-generating and charge transport functions as is well known in the art, or it may comprise multiple layers such as a charge generation layer 5, a charge transport layer 6, and an optional overcoat layer 7.

The Charge Generation Layer

The charge generation layer 5 may thereafter be applied to the undercoat layer 3. Any suitable charge generation binder including a charge generating/photoconductive material, which may be in the form of particles and dispersed in a film forming binder, such as an inactive resin, may be utilized. Examples of charge generating materials include, for example, inorganic photoconductive materials such as amorphous selenium, trigonal selenium, and selenium alloys selected from selenium-tellurium, selenium-tellurium-arsenic, selenium arsenide and mixtures thereof, and organic photoconductive materials including various phthalocyanine pigments such as the X-form of metal free phthalocyanine, metal phthalocyanines such as vanadyl phthalocyanine and copper phthalocyanine, hydroxy gallium phthalocyanines, chlorogallium phthalocyanines, titanyl phthalocyanines, quinacridones, dibromo anthanthrone pigments, benzimidazole perylene, substituted 2,4-diamino-triazines, polynuclear aromatic quinones, enzimidazole perylene, and the like, and mixtures thereof, dispersed in a film forming polymeric binder. Selenium, selenium alloy, benzimidazole perylene, and the like and mixtures thereof may be formed as a continuous, homogeneous charge generation layer. Benzimidazole perylene compositions are well known and described, for example, in U.S. Pat. No. 4,587,189, the entire disclosure thereof being incorporated herein by reference. Multi-charge generation layer compositions may be used where a photoconductive layer enhances or reduces the properties of the charge generation layer. Other suitable charge generating materials known in the art may also be utilized, if desired. The charge generating materials selected should be sensitive to activating radiation having a wavelength between about 400 nanometers and about 900 nanometers during the imagewise radiation exposure step in an electrophotographic imaging process to form an electrophotographic latent image. For example, hydroxygallium phthalocyanine absorbs light of a wavelength of from about 370 nanometers to about 950 nanometers, as disclosed, for example, in U.S. Pat. No. 5,756,245.

A number of titanyl phthalocyanines, or oxytitanium phthalocyanines for the photoconductors illustrated herein are photogenerating pigments known to absorb near infrared light around 800 nanometers, and may exhibit improved sensitivity compared to other pigments, such as, for example, hydroxygallium phthalocyanine. Generally, titanyl phthalocyanine is known to have five main crystal forms known as Types I, II, III, X, and IV. For example, U.S. Pat. Nos. 5,189,155 and 5,189,156, the disclosures of which are totally incorporated herein by reference, disclose a number of methods for obtaining various polymorphs of titanyl phthalocyanine. Additionally, U.S. Pat. Nos. 5,189,155 and 5,189,156 are directed to processes for obtaining Types I, X, and IV phthalocyanines. U.S. Pat. No. 5,153,094, the disclosure of which is totally incorporated herein by reference, relates to the preparation of titanyl phthalocyanine polymorphs including Types I, II, III, and IV polymorphs. U.S. Pat. No. 5,166,339, the disclosure of which is totally incorporated herein by reference, discloses processes for preparing Types I, IV, and X titanyl phthalocyanine polymorphs, as well as the preparation of two polymorphs designated as Type Z-1 and Type Z-2.

Any suitable inactive resin materials may be employed as a binder in the charge generation layer 5, including those described, for example, in U.S. Pat. No. 3,121,006, the entire disclosure thereof being incorporated herein by reference. Organic resinous binders include thermoplastic and thermosetting resins such as one or more of polycarbonates, polyesters, polyamides, polyurethanes, polystyrenes, polyarylethers, polyarylsulfones, polybutadienes, polysulfones, polyethersulfones, polyethylenes, polypropylenes, polyimides, polymethylpentenes, polyphenylene sulfides, polyvinyl butyral, polyvinyl acetate, polysiloxanes, polyacrylates, polyvinyl acetals, polyamides, polyimides, amino resins, phenylene oxide resins, terephthalic acid resins, epoxy resins, phenolic resins, polystyrene and acrylonitrile copolymers, polyvinylchloride, vinylchloride and vinyl acetate copolymers, acrylate copolymers, alkyd resins, cellulosic film formers, poly(amideimide), styrene-butadiene copolymers, vinylidenechloride/vinylchloride copolymers, vinylacetate/vinylidene chloride copolymers, styrene-alkyd resins, and the like. Another film-forming polymer binder is PCZ-400 (poly(4,4′-dihydroxy-diphenyl-1-1-cyclohexane) which has a viscosity-molecular weight of 40,000 and is available from Mitsubishi Gas Chemical Corporation (Tokyo, Japan).

The charge generating material can be present in the resinous binder composition in various amounts. Generally, at least about 5 percent by volume, or no more than about 90 percent by volume of the charge generating material is dispersed in at least about 95 percent by volume, or no more than about 10 percent by volume of the resinous binder, and more specifically at least about 20 percent by volume, or no more than about 60 percent by volume of the charge generating material is dispersed in at least about 80 percent by volume, or no more than about 40 percent by volume of the resinous binder composition.

In specific embodiments, the charge generation layer 5 may have a thickness of at least about 0.1 micron, or no more than about 2 microns, or of at least about 0.2 micron, or no more than about 1 micron. These embodiments may be comprised of chlorogallium phthalocyanine or hydroxygallium phthalocyanine or mixtures thereof. The charge generation layer 5 containing the charge generating material and the resinous binder material generally ranges in thickness of at least about 0.1 micron, or no more than about 5 microns, for example, from about 0.2 micron to about 3 microns when dry. The charge generation layer thickness is generally related to binder content. Higher binder content compositions generally employ thicker layers for charge generation, for example, from about 0.1 micron to about 2 microns.

The Charge Transport Layer

The charge transport layer 6 is thereafter applied over the charge generation layer 5 and may include any suitable transparent organic polymer or non-polymeric material capable of supporting the injection of photogenerated holes or electrons from the charge generation layer 5 and capable of allowing the transport of these holes/electrons through the charge transport layer to selectively discharge the surface charge on the imaging member surface. In one embodiment, the charge transport layer 6 not only serves to transport holes, but also protects the charge generation layer 5 from abrasion or chemical attack and may therefore extend the service life of the imaging member. The charge transport layer 6 can be a substantially non-photoconductive material, but one which supports the injection of photogenerated holes from the charge generation layer 5.

The charge transport layer 6 is normally transparent in a wavelength region in which the electrophotographic imaging member is to be used when exposure is affected there to ensure that most of the incident radiation is utilized by the underlying charge generation layer 5. The charge transport layer should exhibit excellent optical transparency with negligible light absorption and no charge generation when exposed to a wavelength of light useful in xerography, e.g., 400 nanometers to 900 nanometers. In the case when the photoreceptor is prepared with the use of a transparent substrate 1 and also a transparent or partially transparent conductive layer 2, image wise exposure or erase may be accomplished through the substrate 1 with all light passing through the back side of the substrate. In this case, the materials of the charge transport layer 6 need not transmit light in the wavelength region of use if the charge generation layer 5 is sandwiched between the substrate and the charge transport layer 6. The charge transport layer 6 in conjunction with the charge generation layer 5 is an insulator to the extent that an electrophotographic charge placed on the charge transport layer is not conducted in the absence of illumination. The charge transport layer 6 should trap minimal charges as the charge passes through it during the discharging process.

The charge transport layer 6 may include any suitable charge transport component or activating compound useful as an additive dissolved or molecularly dispersed in an electrically inactive polymeric material, such as a polycarbonate binder, to form a solid solution and thereby making this material electrically active. “Dissolved” refers, for example, to forming a solution in which the small molecule is dissolved in the polymer to form a homogeneous phase; and molecularly dispersed in embodiments refers, for example, to charge transporting molecules dispersed in the polymer, the small molecules being dispersed in the polymer on a molecular scale. The charge transport component may be added to a film forming polymeric material which is otherwise incapable of supporting the injection of photogenerated holes from the charge generation material and incapable of allowing the transport of these holes through. This addition converts the electrically inactive polymeric material to a material capable of supporting the injection of photogenerated holes from the charge generation layer 5 and capable of allowing the transport of these holes through the charge transport layer 6 in order to discharge the surface charge on the charge transport layer. The high mobility charge transport component may comprise small molecules of an organic compound which cooperate to transport charge between molecules and ultimately to the surface of the charge transport layer.

Non-limiting examples of specific aryl amines include N,N′-diphenyl-N,N′-bis(3-methylphenyl)-(1,1′-biphenyl)-4,4′-diamine (mTBD), other arylamines like N,N,N′,N′-tetra-p-tolyl-1,1′-biphenyl-4,4′-diamine (TmTBD), and the like.

Other arylamine examples include N,N′-diphenyl-N,N′-bis(alkylphenyl)-1,1-biphenyl-4,4′-diamine wherein alkyl is selected from the group consisting of methyl, ethyl, propyl, butyl, hexyl, and the like; N,N′-diphenyl-N,N′-bis(halophenyl)-1,1′-biphenyl-4,4′-diamine wherein the halo substituent is a chloro substituent; N,N′-bis(4-butylphenyl)-N,N′-di-p-tolyl-[p-terphenyl]-4,4″-diamine, N,N′-bis(4-butylphenyl)-N,N′-di-m-tolyl-[p-terphenyl]-4,4″-diamine, N,N′-bis(4-butylphenyl)-N,N′-di-o-tolyl-[p-terphenyl]-4,4″-diamine, N,N′-bis(4-butylphenyl)-N,N′-bis-(4-isopropylphenyl)-[p-terphenyl]-4,4″-diamine, N,N′-bis(4-butylphenyl)-N,N′-bis-(2-ethyl-6-methylphenyl)-[p-terphenyl]-4,4″diamine, N,N′-bis(4-butylphenyl)-N,N′-bis-(2,5-dimethylphenyl)-[p-terphenyl]-4,4′-diamine, N,N′-diphenyl-N,N′-bis(3-chlorophenyl)-[p-terphenyl]-4,4″-diamine, tetra-p-tolyl-biphenyl-4,4′-diamine, N,N′-diphenyl-N,N′-bis(4-methoxyphenyl)-1,1-biphenyl-4,4′-diamine, and the like. Other known charge transport layer molecules can be selected, reference for example, U.S. Pat. Nos. 4,921,773 and 4,464,450, the disclosures of which are totally incorporated herein by reference.

In embodiments, the charge transport arylamine component can be represented by the following formulas/structures

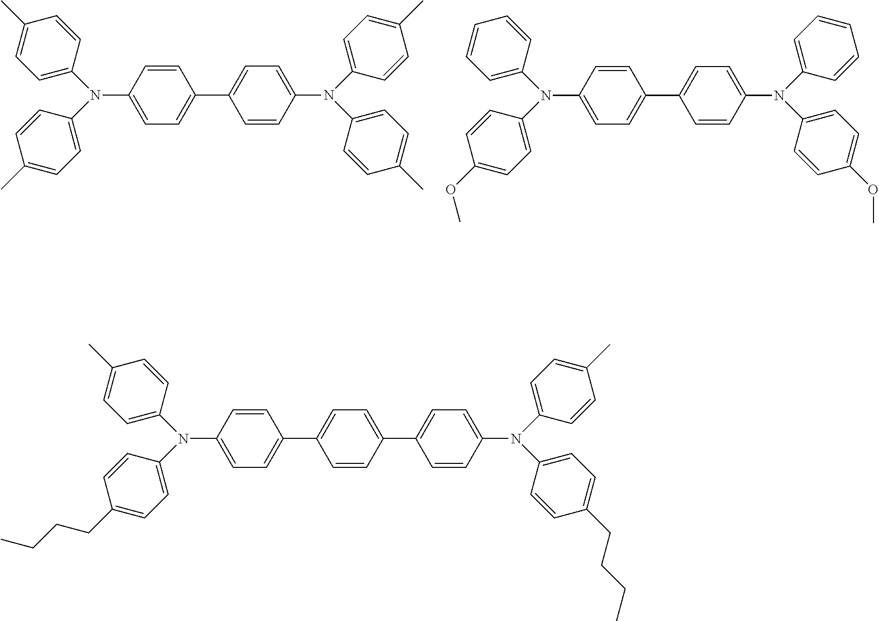

Examples of the binder materials selected for the charge transport layers include components, such as those described in U.S. Pat. No. 3,121,006, the disclosure of which is totally incorporated herein by reference. Specific examples of polymer binder materials include polycarbonates, polyarylates, acrylate polymers, vinyl polymers, cellulose polymers, polyesters, polysiloxanes, polyamides, polyurethanes, poly(cyclo olefins), and epoxies, and random or alternating copolymers thereof. In embodiments, electrically inactive binders are comprised of polycarbonate resins with for example a molecular weight of from about 20,000 to about 150,000 and more specifically with a molecular weight M_{w} of from about 30,000 to about 100,000. Examples of polycarbonates are poly(4,4′-isopropylidene-diphenylene)carbonate (also referred to as bisphenol-A-polycarbonate, poly(4,4′-cyclohexylidinediphenylene) carbonate (referred to as bisphenol-Z polycarbonate), poly(4,4′-isopropylidene-3,3′-dimethyl-diphenyl)carbonate (also referred to as bisphenol-C-polycarbonate) and the like. In embodiments, the charge transport layer, such as a hole transport layer, may have a thickness from about 10 microns to about 40 microns.

The charge transport layer may further include a polymeric binder having a viscosity-molecular weight of from about 20,000 to about 150,000, or from about 30,000 to about 80,000. For example, in embodiments, the polymeric binder may be a polycarbonate Z polymer, or poly(4,4′-diphenyl-1,1′-cyclohexane carbonate (PCZ-400). The polymeric binder may be present in the charge transport layer in an amount of about 40 percent to about 80 percent, or about 50 percent to about 80 percent, by weight of total weight of the charge transport layer. In embodiments, a ratio of the charge transport molecule to the polymeric binder present in the charge transport layer is from about 20:80 to about 60:40, or from about 25:75 to about 50:50. In further embodiments, the charge transport layer may also comprise polytetrafluoroethylene (PTFE) particles uniformly dispersed throughout the polymeric binder to extend the life of the imaging member. The embodiments do, however, also cover imaging members where particle additives are not added to the charge transport layer.

Examples of components or materials optionally incorporated into the charge transport layers or at least one charge transport layer to, for example, enable improved lateral charge migration (LCM) resistance include hindered phenolic antioxidants such as tetrakis methylene(3,5-di-tert-butyl-4-hydroxy hydrocinnamate) methane (IRGANOX® 1010, available from Ciba Specialty Chemical), butylated hydroxytoluene (BHT), and other hindered phenolic antioxidants including SUMILIZER™ BHT-R, MDP-S, BBM-S, WX-R, NR, BP-76, BP-101, GA-80, GM and GS (available from Sumitomo Chemical Co., Ltd.), IRGANOX® 1035, 1076, 1098, 1135, 1141, 1222, 1330, 1425WL, 1520L, 245, 259, 3114, 3790, 5057 and 565 (available from Ciba Specialties Chemicals), and ADEKA STAB™ AO-20, AO-30, AO-40, AO-50, AO-60, AO-70, AO-80 and AO-330 (available from Asahi Denka Co., Ltd.); hindered amine antioxidants such as SANOL™ LS-2626, LS-765, LS-770 and LS-744 (available from SANKYO CO., Ltd.), TINUVIN® 144 and 622LD (available from Ciba Specialties Chemicals), MARKT™ LA57, LA67, LA62, LA68 and LA63 (available from Asahi Denka Co., Ltd.), and SUMILIZER® TPS (available from Sumitomo Chemical Co., Ltd.); thioether antioxidants such as SUMILIZER® TP-D (available from Sumitomo Chemical Co., Ltd); phosphite antioxidants such as MARK™ 2112, PEP-8, PEP-24G, PEP-36, 329K and HP-10 (available from Asahi Denka Co., Ltd.); other molecules such as bis(4-diethylamino-2-methylphenyl)phenylmethane (BDETPM), bis-[2-methyl-4-(N-2-hydroxyethyl-N-ethyl-aminophenyl)]-phenylmethane (DHTPM), and the like. The weight percent of the antioxidant in at least one of the charge transport layer is from about 0 weight percent to about 20 weight percent, from about 1 weight percent to about 10 weight percent, or from about 3 weight percent to about 8 weight percent.

In the present embodiments, a number of additives may be further included as hole transport molecules in addition to the aryl amines. For example, tris(enylaryl)amines such as tris(butadienylaryl)amines can be included in the charge transport layer or charge transport layers. In specific embodiments, the charge transport layer comprises a combination of TmTBD and a tris(butadienylaryl)amine as hole transport molecules. In embodiments, the tris(enylaryl)amine has a general formula as shown below:

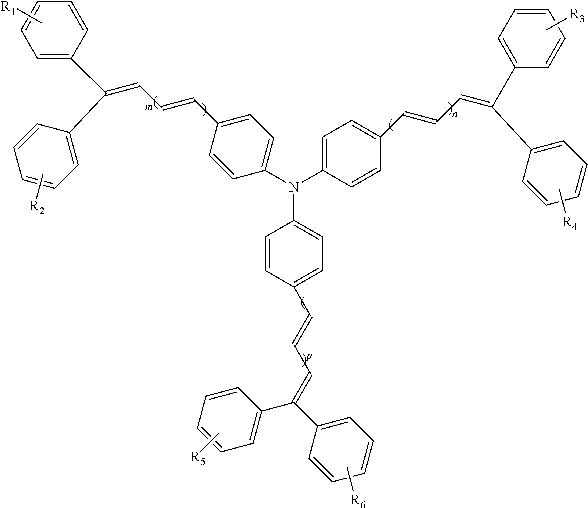

wherein each R is hydrogen, alkyl, alkoxy, aryl, substituted derivatives thereof, halo, and the like; and m, n, and p each represents the number of repeating segments, such as 0 or 1.

More specifically, examples of the charge transport layer additives are tris(butadienylaryl)amines such as tris[4-(4,4-diphenyl-1,3-butadienyl)phenyl]amine (T-693 available from Takasago Chemical Corp., Tokyo, Japan) and tris[4-(4,4-dimethylphenyl-1,3-butadienyl)phenyl]amine, and the like, and mixtures thereof.

In embodiments, the additive can be represented by the following:

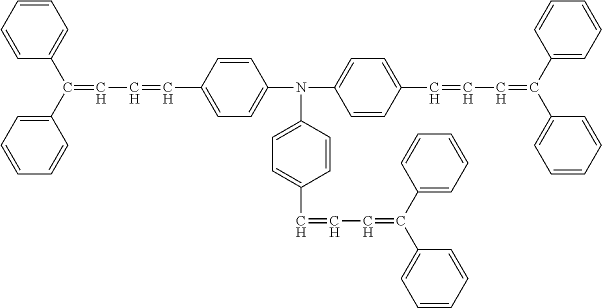

It has been discovered that this formulation provides the imaging member with substantially reduced C zone residual potential (V) and lower ghosting, even in high speed applications. Moreover, imaging members comprising such charge transport layers exhibit reduced crystallization that conventional imaging members comprising only TmTBD suffer from. Because crystallization tends to increase as the thickness of the charge transport layer increases, the conventional imaging members are limited to specific thicknesses.

In embodiments, a weight ratio of TmTBD to tris(butadienylaryl)amine may be from about 1:99 to about 99:1, or from about 5:95 to about 95:5, or from about 10:90 to about 90:10, respectively. In embodiments, the TmTBD is present in the charge transport layer in an amount of from about 10 percent to about 55 percent, or from about 15 percent to about 50 percent, or from about 20 percent to about 45 percent by weight of the total weight of the charge transport layer. In embodiments, the tris(butadienylaryl)amine is present in the charge transport layer in an amount of from about 1 percent to about 30 percent, or from about 2 percent to about 25 percent, or from about 3 percent to about 15 percent by weight of the total weight of the charge transport layer. In further embodiments, a total amount of hole transport molecules is from about 20 percent to about 80 percent, or from about 25 percent to about 75 percent, or from about 30 percent to about 70 percent by weight of the total weight of the charge transport layer.

In embodiments, the thickness of the charge transport layer after drying is from about 10 microns to about 50 microns or from about 15 microns to about 40 microns for optimum photoelectrical and mechanical results. In another embodiment the thickness is from about 20 microns to about 34 microns. As stated above, thicker charge transport layers can be achieved with the present embodiments because the combination of the specific aryl amines with the tris(butadienylaryl)amine does not suffer from increased crystallization.

The charge transport layer should be an insulator to the extent that the electrostatic charge placed on the hole transport layer is not conducted in the absence of illumination at a rate sufficient to prevent formation and retention of an electrostatic latent image thereon. The charge transport layer is substantially nonabsorbing to visible light or radiation in the region of intended use, but is electrically “active” in that it allows the injection of photogenerated holes from the photoconductive layer, that is the charge generation layer, and allows these holes to be transported through itself to selectively discharge a surface charge on the surface of the active layer.

Any suitable and conventional technique may be utilized to form and thereafter apply the charge transport layer mixture to the supporting substrate layer. The charge transport layer may be formed in a single coating step or in multiple coating steps. Dip coating, ring coating, spray, gravure or any other drum coating methods may be used. Drying of the deposited coating may be effected by any suitable conventional technique such as oven drying, infra red radiation drying, air drying and the like.

The Overcoat Layer

Other layers of the imaging member may include, for example, an over coat layer 7. An overcoat layer 7, if desired, may be disposed over the charge transport layer 6 to provide imaging member surface protection as well as improve resistance to abrasion. In embodiments, the overcoat layer 7 may have a thickness ranging from about 0.1 micron to about 10 microns or from about 1 micron to about 10 microns, or in a specific embodiment, about 3 microns. These overcoat layers may include thermoplastic organic polymers or inorganic polymers that are electrically insulating or slightly semi-conductive. For example, overcoat layers may be fabricated from a dispersion including a particulate additive in a resin. Suitable particulate additives for overcoat layers include metal oxides including aluminum oxide, non-metal oxides including silica or low surface energy polytetrafluoroethylene (PTFE), and combinations thereof. Suitable resins include those described above as suitable for photogenerating layers and/or charge transport layers, for example, polyvinyl acetates, polyvinylbutyrals, polyvinylchlorides, vinylchloride and vinyl acetate copolymers, carboxyl-modified vinyl chloride/vinyl acetate copolymers, hydroxyl-modified vinyl chloride/vinyl acetate copolymers, carboxyl- and hydroxyl-modified vinyl chloride/vinyl acetate copolymers, polyvinyl alcohols, polycarbonates, polyesters, polyurethanes, polystyrenes, polybutadienes, polysulfones, polyarylethers, polyarylsulfones, polyethersulfones, polyethylenes, polypropylenes, polymethylpentenes, polyphenylene sulfides, polysiloxanes, polyacrylates, polyvinyl acetals, polyamides, polyimides, amino resins, phenylene oxide resins, terephthalic acid resins, phenoxy resins, epoxy resins, phenolic resins, polystyrene and acrylonitrile copolymers, poly-N-vinylpyrrolidinones, acrylate copolymers, alkyd resins, cellulosic film formers, poly(amideimide), styrene-butadiene copolymers, vinylidenechloride-vinylchloride copolymers, vinylacetate-vinylidenechloride copolymers, styrene-alkyd resins, polyvinylcarbazoles, and combinations thereof. Overcoat layers may be continuous and have a thickness of at least about 0.5 micron, or no more than 10 microns, and in further embodiments have a thickness of at least about 2 microns, or no more than 6 microns.

In the present embodiments, there is also included an overcoat layer that provides both long service life and exhibits better electrical performance than conventional overcoat layers in xerography systems. In embodiments, the overcoat layer solution comprises an alcohol soluble small transport molecule such as, for example, N,N′-diphenyl-N,N′-bis(3-hydroxyphenyl)-[1,1′-biphenyl]-4,4′-diamine (DHTBD), or N,N′-diphenyl-N,N′-di[3-hydroxyphenyl]-terphenyl-diamine (DHTER), and a crosslinking agent such as, for example, a melamine formaldehyde crosslinking agent. In specific embodiments, the melamine formaldehyde crosslinking agent may be selected from the group consisting of a methylated, or a butylated melamine-formaldehyde agent and mixtures thereof and the like. A nonlimiting example of a suitable methoxymethylated melamine compound can be CYMEL® 303 (available from Cytec Industries), which is a methoxymethylated melamine compound with the formula (CH₃OCH₂)₆N₃C₃N₃.

In embodiments, a weight ratio of DHTBD to the melamine formaldehyde crosslinking agent may be from about 30:70 to about 70:30, or from about 35:65 to about 65:35, or from about 40:60 to about 60:40, respectively. In further embodiments, the DHTBD may be present in the overcoat layer in an amount of from about 30 percent to about 70 percent, or from about 35 percent to about 65 percent, or from about 40 percent to about 60 percent by weight of the total weight of the overcoat layer. In further embodiments, the melamine crosslinking agent may be present in the overcoat layer in an amount of from about 70 percent to about 30 percent, or from about 65 percent to about 35 percent, or from about 60 percent to about 40 percent by weight of the total weight of the overcoat layer.

Crosslinking can be accomplished by heating the overcoat components in the presence of a catalyst. Non-limiting examples of catalysts include oxalic acid, maleic acid, carbolic acid, ascorbic acid, malonic acid, succinic acid, tartaric acid, citric acid, p-toluenesulfonic acid (pTSA), methanesulfonic acid, dodecylbenzene sulfonic acid (DDBSA), dinonylnaphthalene disulfonic acid (DNNDSA), dinonylnaphthalene monosulfonic acid (DNNSA), and the like, and mixtures thereof.

Additionally, there may be included in the overcoat layer low surface energy components, such as hydroxyl terminated fluorinated additives, hydroxyl silicone modified polyacrylates, and mixtures thereof. Examples of the low surface energy components, present in various effective amounts, such as from about 0.1 weight percent to about 25 weight percent, from about 0.5 weight percent to about 15 weight percent, from about 1 weight percent to about 10 weight percent, are hydroxyl derivatives of perfluoropolyoxyalkanes such as FLUOROLINK® D (M.W. about 1,000 and fluorine content about 62 percent), FLUOROLINK® D10-H (M.W. about 700 and fluorine content about 61 percent), and FLUOROLINK® D10 (M.W. about 500 and fluorine content about 60 percent) (functional group —CH₂OH); FLUOROLINK® E (M.W. about 1,000 and fluorine content about 58 percent) and FLUOROLINK® E10 (M.W. about 500 and fluorine content about 56 percent) (functional group —CH₂(OCH₂CH₂)ₙOH); FLUOROLINK® T (M.W. about 550 and fluorine content about 58 percent) and FLUOROLINK® T10 (M.W. about 330 and fluorine content about 55 percent) (functional group —CH₂OCH₂CH(OH)CH₂OH); and hydroxyl derivatives of perfluoroalkanes (R_{f}CH₂CH₂OH, wherein R_{f}═F(CF₂CF₂)ₙ) such as ZONYL® BA (M.W. about 460 and fluorine content about 71 percent), ZONYL® BA-L (M.W. about 440 and fluorine content about 70 percent), ZONYL® BA-LD (M.W. about 420 and fluorine content about 70 percent), and ZONYL® BA-N (M.W. about 530 and fluorine content about 71 percent); carboxylic acid derivatives of fluoropolyethers such as FLUOROLINK® C (M.W. about 1,000 and fluorine content about 61 percent), carboxylic ester derivatives of fluoropolyethers such as FLUOROLINK® L (M.W. about 1,000 and fluorine content about 60 percent), FLUOROLINK® L10 (M.W. about 500 and fluorine content about 58 percent), carboxylic ester derivatives of perfluoroalkanes (R_{f}CH₂CH₂O(C═O)R, wherein R_{f}═F(CF₂CF₂)ₙ and R is alkyl) such as ZONYL® TA-N (fluoroalkyl acrylate, R═CH₂═CH—, M.W. about 570 and fluorine content about 64 percent), ZONYL® TM (fluoroalkyl methacrylate, R═CH₂═C(CH₃)—, M.W. about 530 and fluorine content about 60 percent), ZONYL® FTS (fluoroalkyl stearate, R═C₁₇H₃₅—, M.W. about 700 and fluorine content about 47 percent), ZONYL® TBC (fluoroalkyl citrate, M.W. about 1,560 and fluorine content about 63 percent), sulfonic acid derivatives of perfluoroalkanes (R_{f}CH₂CH₂ SO₃H, wherein R_{f}═F(CF₂CF₂)ₙ) such as ZONY®L TBS (M.W. about 530 and fluorine content about 62 percent); ethoxysilane derivatives of fluoropolyethers such as FLUOROLINK® S10 (M.W. about 1,750 to 1,950); phosphate derivatives of fluoropolyethers such as FLUOROLINK® F10 (M.W. about 2,400 to 3,100); hydroxyl derivatives of silicone modified polyacrylates such as BYK-SILCLEAN® 3700; polyether modified acryl polydimethylsiloxanes such as BYK-SILCLEAN® 3710; and polyether modified hydroxyl polydimethylsiloxanes such as BYK-SILCLEAN® 3720. FLUOROLINK® is a trademark of Ausimont, Inc., ZONYL® is a trademark of E.I. DuPont, and BYK-SILCLEAN® is a trademark of BYK Silclean.

The overcoat layer may be prepared similarly to the above-described layers. For example, any suitable and conventional technique may be utilized to form and thereafter apply the overcoat layer mixture to the charge transport layer. The overcoat layer may be formed in a single coating step or in multiple coating steps. Dip coating, ring coating, spray, gravure or any other drum coating methods may be used. Drying of the deposited coating may be effected by any suitable conventional technique such as oven drying, infra red radiation drying, air drying and the like.

While the description above refers to particular embodiments, it will be understood that many modifications may be made without departing from the spirit thereof. The accompanying claims are intended to cover such modifications as would fall within the true scope and spirit of embodiments herein.

The presently disclosed embodiments are, therefore, to be considered in all respects as illustrative and not restrictive, the scope of embodiments being indicated by the appended claims rather than the foregoing description. All changes that come within the meaning of and range of equivalency of the claims are intended to be embraced therein.

### EXAMPLES

The example set forth herein below is illustrative of different compositions and conditions that can be used in practicing the present embodiments. All proportions are by weight unless otherwise indicated. It will be apparent, however, that the embodiments can be practiced with many types of compositions and can have many different uses in accordance with the disclosure above and as pointed out hereinafter.

The embodiments will be described in further detail with reference to the following examples and comparative examples. All the “parts” and “%” used herein mean parts by weight and % by weight unless otherwise specified.

### Control Example

A three component hole blocking or undercoat layer was prepared as follows. Zirconium acetylacetonate tributoxide (35.5 parts), γ-aminopropyl triethoxysilane (4.8 parts), and poly(vinyl butyral) BM-S (2.5 parts) were dissolved in n-butanol (52.2 parts). The coating solution was coated via a dip coater, and the layer was pre-heated at 59° C. for 13 minutes, humidified at 58° C. (dew point=54° C.) for 17 minutes, and dried at 135° C. for 8 minutes. The thickness of the undercoat layer was approximately 1.3 microns.

A charge generation layer at a thickness of about 0.2 micron comprising hydroxygallium phthalocyanine Type V was deposited on the above hole blocking layer or undercoat layer. The charge generation layer coating dispersion was prepared as follows: 3 grams of the hydroxygallium Type V pigment were mixed with 2 grams of a polymeric binder of a carboxyl-modified vinyl copolymer, VMCH, available from Dow Chemical Company, and 45 grams of n-butyl acetate. The resulting mixture was milled in an Attritor mill with about 200 grams of 1 millimeter Hi-Bea borosilicate glass beads for about 3 hours. The dispersion obtained was filtered through a 20 micron Nylon cloth filter, and the solid content of the dispersion was diluted to about 6 weight percent.

Subsequently, a 24 micron thick charge transport layer was coated on top of the charge generation layer from a solution prepared from N,N′-diphenyl-N,N-bis(3-methylphenyl)-1,1′-biphenyl-4,4′-diamine (5 grams), a film forming polymer binder PCZ-400 [poly(4,4′-dihydroxy-diphenyl-1-1-cyclohexane, M_{w}=40,000)] available from Mitsubishi Gas Chemical Company, Ltd. (7.5 grams) in a solvent mixture of 30 grams of tetrahydrofuran (THF) and 10 grams of monochlorobenzene (MCB) via simple mixing. The charge transport layer comprised of PCZ-400/mTBD at a mixture ratio of 60:40 was dried at about 135° C. for about 40 minutes.

An overcoat layer was applied to the charge transport layer. The overcoat layer solution was formed by adding 8.3 grams of CYMEL® 303 (a methylated, butylated melamine-formaldehyde crosslinking agent obtained from Cytec Industries Inc.), 9.7 grams of N,N′-diphenyl-N,N′-bis(3-hydroxyphenyl)-[1,1′-biphenyl]-4,4′-diamine (DHTBD), 0.72 gram of BYK-SILCLEAN® 3700 (a hydroxylated silicone modified polyacrylate obtained from BYK-Chemie USA), and 0.9 gram of NACURE® XP357 (a blocked acid catalyst obtained from King Industries) in 72 grams of DOWANOL® PM (1-methoxy-2-propanol obtained from the Dow Chemical Company). The resultant overcoat layer was dried in a forced air oven for 40 minutes at 155° C. to yield a highly crosslinked, 4.5 micron thick overcoat layer, and which overcoat layer was substantially insoluble in methanol or ethanol.

### Disclosure Example

An electrophotographic imaging member was prepared by following the very exact same procedures and material compositions as those described in the Control Example above, but with the exception that the charge transport layer is comprised of PCZ-400/TmTBD/tris[4-(4,4-diphenyl-1,3-butadienyl)phenyl]amine at a mixture ratio of 60:30:10, where tris[4-(4,4-diphenyl-1,3-butadienyl)phenyl]amine was available as T-693 and obtained from Takasago Chemical Corp., Tokyo, Japan.

Testing

The above prepared photoreceptors, each with 24 micron thick charge transport layers, were tested in a scanner set to obtain photoinduced discharge cycles, sequenced at one charge-erase cycle followed by one charge-expose-erase cycle, wherein the light intensity was incrementally increased with cycling and surface potentials at various exposure intensities are measured. The scanner was equipped with a scorotron set to a constant voltage charging at various surface potentials. The photoconductors were scanned at 120 rpm and 50 ms after exposure, and the results are shown below in Table 1.

TABLE 1

| | | A zone | B zone | C zone |
|---|---|---|---|---|
| The disclosed photoconductor | Vᵣ | 92 V | 103 V | 156 V |
| (PCZ-400/TmTBD/T-693 = | Dark decay | 18 V | 21 V | 23 V |
| 60/30/10) | | | | |
| Control photoconductor | Vᵣ | 120 V | 140 V | 201 V |
| (PCZ-400/mTBD = 60/40) | Dark decay | 18 V | 21 V | 25 V |

Table 1 demonstrates that the disclosed photoconductor exhibited about 50V lower C zone Vᵣ than that of the control photoconductor, with no negative impact on the other key properties such as dark decay in all zones.

In addition, the above prepared photoconductors were print tested for ghosting from the most stressful high transfer current Copeland machine, and the results are shown in Table 2.

TABLE 2

| | A zone ghosting at | J zone ghosting at |
|---|---|---|
| | t = 500 prints | t = 500 prints |
| The disclosed photoconductor | G-2.5 | G-1 |
| (PCZ-400/TmTBD/T-693 = | | |
| 60/30/10) | | |
| Control photoconductor | G-4 | G-2.5 |
| (PCZ-400/mTBD = 60/40) | | |

Table 2 demonstrates that compared to the control photoconductor, the disclosed photoconductor exhibited lower ghosting.

It will be appreciated that several of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims. Unless specifically recited in a claim, steps or components of claims should not be implied or imported from the specification or any other claims as to any particular order, number, position, size, shape, angle, color, or material.

What is claimed is:

1. An electrophotographic imaging member comprising:
a substrate;
an undercoat layer disposed on the substrate;
a charge generation layer disposed on the undercoat layer;
a charge transport layer disposed on the charge generation layer, wherein the charge transport layer comprises a polymeric binder, and a combination of hole transport molecules comprising N,N,N′,N′-tetra-p-tolyl-1,1′-biphenyl-4,4′-diamine and a tris(butadienylaryl)amine compound; and
an overcoat layer disposed on the charge transport layer.

2. The electrophotographic imaging member of claim 1, wherein the overcoat layer comprises N,N′-diphenyl-N,N′-bis(3-hydroxyphenyl)-[1,1′-biphenyl]-4,4′-diamine and a melamine resin.

3. The electrophotographic imaging member of claim 2, wherein the melamine resin is selected from the group consisting of a methylated melamine formaldehyde resin or a butylated melamine formaldehyde resin, and mixtures thereof.

4. The electrophotographic imaging member of claim 2, wherein a weight ratio of N,N′-diphenyl-N,N′-bis(3-hydroxyphenyl)-[1,1′-biphenyl]-4,4′-diamine to the melamine resin is from about 30:70 to about 70:30.

5. The electrophotographic imaging member of claim 2, wherein the melamine resin is present in the overcoat layer in an amount of from about 30 percent to about 70 percent by weight of the total weight of the overcoat layer.

6. The electrophotographic imaging member of claim 2, wherein N,N′-diphenyl-N,N′-bis(3-hydroxyphenyl)-[1,1′-biphenyl]-4,4′-diamine is present in the overcoat layer in an amount of from about 70 percent to about 30 percent by weight of the total weight of the overcoat layer.

7. The electrophotographic imaging member of claim 1, wherein the tris(butadienylaryl)amine compound is selected from the group consisting of tris[4-(4,4-diphenyl-1,3-butadienyl)phenyl]amine, tris[4-(4,4-dimethylphenyl-1,3-butadienyl)phenyl]amine, and mixtures thereof.

8. The electrophotographic imaging member of claim 1, wherein a weight ratio of N,N,N′,N′-tetra-p-tolyl-1,1′-biphenyl-4,4′-diamine to the tris(butadienylaryl)amine compound is from about 10/90 to about 90/10.

9. The electrophotographic imaging member of claim 1, wherein a total amount of hole transport molecules present in the charge transport layer is from about 20 percent to about 80 percent by weight of the total weight of the charge transport layer.

10. The electrophotographic imaging member of claim 1, wherein the polymeric binder is poly(4,4′-diphenyl-1,1′-cyclohexane carbonate).

11. The electrophotographic imaging member of claim 1, wherein the undercoat layer is a three component layer comprising Zirconium acetylacetonate tributoxide, γ-aminopropyl triethoxysilane, and poly(vinyl butyral).

12. The electrophotographic imaging member of claim 1, wherein the charge transport layer has a thickness of from about 10 microns to about 50 microns.

13. The electrophotographic imaging member of claim 1, wherein the overcoat layer has a thickness of from about 2 microns to about 10 microns.

14. The electrophotographic imaging member of claim 1, wherein the charge generation layer comprises a phthalocyanine compound.

15. An imaging member comprising:
a substrate;
an undercoat layer; and
an imaging layer disposed on the undercoat layer, wherein the imaging layer comprises N,N,N′,N′-tetra-p-tolyl-1,1′-biphenyl-4,4′-diamine and a tris(butadienylaryl)amine compound; and
an overcoat layer disposed on the imaging layer.

16. The imaging member of claim 15, wherein the substrate is flexible or rigid.

17. The imaging member of claim 15, wherein the tris(butadienylaryl)amine compound has the following formula:

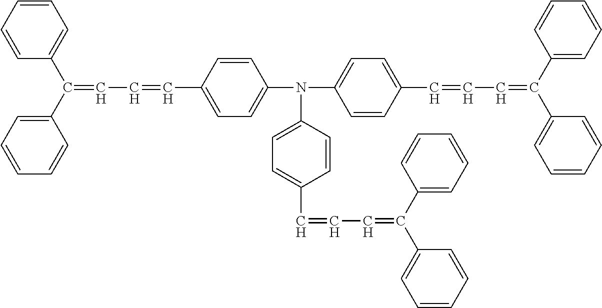

18. The imaging member of claim 15, wherein the tris(butadienylaryl)amine compound is present in an amount of from about 1 percent to about 50 percent by weight of the total weight of the charge transport layer.

19. The imaging member of claim 15, wherein the N,N,N′,N′-tetra-p-tolyl-1,1′-biphenyl-4,4′-diamine is present in an amount of from about 1 percent to about 50 percent by weight of the total weight of the charge transport layer.

20. An image forming apparatus comprising:
an imaging member further comprising
a substrate,
an undercoat layer,
an imaging layer disposed on the undercoat layer, wherein the imaging layer comprises N,N,N′,N′-tetra-p-tolyl-1,1′-biphenyl-4,4′-diamine and a tris(butadienylaryl)amine compound, and
an overcoat layer disposed on the imaging layer;
a charging unit that applies electrostatic charge on the imaging member;
a developing unit that develops toner image onto the imaging member;
a transfer unit that transfers the toner image from the imaging member to a media; and
a cleaning unit that cleans the imaging member.
